(19) United States
(12) Patent Application Publication
(10) Pub. No.: US 2010/0037854 A1
(43) Pub. Date: Feb. 18, 2010

(54) Apparatus and method for engine braking

(76) Inventor: Zhou Yang, Oak Ridge, NC (US)

Correspondence Address: Zhou Yang, 5811 Crutchfield Farm Road, Oak Ridge, NC, 27310, US

(21) Appl. No.: 12/228,901

(22) Filed: Aug. 18, 2008

(51) Int. Cl. F02D 13/04

(52) U.S. Cl. 123/321

(57) ABSTRACT

Apparatus and method are disclosed for converting an internal combustion engine from a normal engine operation (20) to an engine braking operation (30). The engine has an exhaust valve train containing at least one exhaust valve (300a or 300) and an exhaust valve lifter (200). The apparatus has an actuation means (100) including a dedicated load supporting system and a hydraulic system. The hydraulic system is integrated into the exhaust valve train and has a hydraulic piston (160) that can slide between an inoperative position (0) and an operative position (1). In the inoperative position (0), the hydraulic piston (160) is retracted and separated from the dedicated load supporting system, and the actuation means (100) is disengaged from the at least one exhaust valve (300a or 300). In the operative position (1), the hydraulic piston (160) is extended and engaged with the dedicated load supporting system, and the actuation means (100) opens the at least one exhaust valve (300a or 300) for the engine braking operation (30). The dedicated load supporting system includes a dedicated valve lifter (200b) for the engine braking operation (30). The dedicated load supporting system may also includes a housing (125) that is used to hold the at least one exhaust valve (300a or 300) open when the hydraulic piston (160) is at the extended or operative position (1), which is reached after the at least one exhaust valve (300a or 300) is actuated by the normal exhaust valve lifter (200). The apparatus also has a control means (50) for moving the hydraulic piston (160) between the inoperative position (0) and the operative position (1).

### BACKGROUND OF THE INVENTION

1. Field of Invention

The present invention relates generally to the braking of an internal combustion engine, specifically to engine braking apparatus and method for converting an internal combustion engine from a normal engine operation to an engine-braking operation.

2. Prior Art

It is well known in the art to employ an internal combustion engine as brake means by, in effect, converting the engine temporarily into a compressor. It is also well known that such conversion may be carried out by cutting off the fuel and opening the exhaust valve(s) at or near the end of the compression stroke of the engine piston. By allowing compressed gas (typically, air) to be released, energy absorbed by the engine to compress the gas during the compression stroke is not returned to the engine piston during the subsequent expansion or “power” stroke, but dissipated through the exhaust and radiator systems of the engine. The net result is an effective braking of the engine.

An engine brake is desirable for an internal combustion engine, particularly for a compression ignition type engine, also known as a diesel engine. Such engine offers substantially no braking when it is rotated through the drive shaft by the inertia and mass of a forward moving vehicle. As vehicle design and technology have advanced, its hauling capacity has increased, while at the same time rolling and wind resistances have decreased. Accordingly, there is a heightened braking need for a diesel-powered vehicle. While the normal drum or disc type wheel brakes of the vehicle are capable of absorbing a large amount of energy over a short period of time, their repeated use, for example, when operating in hilly terrain, could cause brake overheating and failure. The use of an engine brake will substantially reduce the use of the wheel brakes, minimize their wear, and obviate the danger of accidents resulting from brake failure.

There are different types of engine brakes. Typically, an engine braking operation is achieved by adding an auxiliary engine valve event called an engine braking event to the normal engine valve event. Depending on how the engine valve event is produced, an engine brake can be defined as:
(a) Type I engine brake—the engine braking event is produced by importing motions from a neighboring cam, which generates the so called “Jake” brake;
(b) Type II engine brake—the engine braking event is produced by altering existing cam profile, which generates a lost motion type engine brake;
(c) Type III engine brake—the engine braking event is produced by using a dedicated valve lifter for engine braking, which generates a dedicated cam (rocker) brake;
(d) Type IV engine brake—the engine braking event is produced by modifying the existing engine valve lift, which normally generates a bleeder type engine brake;
(e) Type V engine brake—the engine braking event is produced by using a dedicated valve train for engine braking, which generates a dedicated valve (the fifth valve) engine brake.

The engine brake can also be divided into two big categories, i.e., the compression release engine brake (CREB) and the bleeder type engine brake (BTEB).

### Compression Release Engine Brake (CREB)

Conventional compression release engine brakes (CREB) open the exhaust valve(s) at or near the end of the compression stroke of the engine piston. They typically include hydraulic circuits for transmitting a mechanical input to the exhaust valve(s) to be opened. Such hydraulic circuits typically include a master piston that is reciprocated in a master piston bore by a mechanical input from the engine, for example, the pivoting motion of the injector rocker arm. Hydraulic fluid in the circuit transmits the master piston motion to a slave piston in the circuit, which in turn, reciprocates in a slave piston bore in response to the flow of hydraulic fluid in the circuit. The slave piston acts either directly or indirectly on the exhaust valve(s) to be opened during the engine braking operation.

An example of a prior art CREB is provided by the disclosure of Cummins, U.S. Pat. No. 3,220,392 (“the '392 patent”), which is hereby incorporated by reference. Engine braking systems based on the '392 patent have enjoyed great commercial success. However, the prior art engine braking system is a bolt-on accessory that fits above the overhead. In order to provide space for mounting the braking system, a spacer may be positioned between the cylinder head and the valve cover that is bolted to the spacer. This arrangement may add unnecessary height, weight, and costs to the engine. Many of the above-noted problems result from viewing the braking system as an accessory to the engine rather than as part of the engine itself.

Another disadvantage associated with the conventional prior art CREB system is due to the fact that the load from engine braking is supported by the engine components. Because the engine braking load is much higher than the normal engine operation load, many parts of the engine, such as the rocker arm, the push tube, the cam, etc. must be modified to accommodate the engine braking system. Thus, the overall weight, height, and cost of using the prior art CREB system are likely to be excessive, and limit its application.

As the market for compression release-type engine brakes (CREB) has developed and matured, there is a need for design systems that reduce the weight, size and cost of such retarding systems, and improve the inter-relation of various ancillary equipments, such as the turbocharger and the exhaust brake with the retarding system. In addition, the market for compression release engine brakes has moved from the after-market, to original equipment manufacturers. Engine manufacturers have shown an increased willingness to make design modifications to their engines that would increase the performance and reliability and broaden the operating parameters of the compression release-type engine brake.

One possible solution is to use a dedicated valve lifter for the engine braking. U.S. Pat. No. 5,626,116 (“the '116 patent”) discloses a dedicated engine braking system (a Type III engine brake) including a rocker arm having a plunger, or braking piston, positioned in a cylinder integrally formed in one end of the rocker arm wherein the plunger can be locked in an outer position by hydraulic pressure to permit braking system operation. A solenoid valve or control valve is also integrated into the dedicated rocker arm. A cam designed exclusively for engine braking has only the small cam lobes for engine braking. Therefore, the engine braking performance can be optimized without interfering with the valve lift profile design for the normal engine operation. During the normal engine operation, the control valve sits in a dent on the rocker shaft and the engine braking rocker arm stays in a neutral position. There are one gap between the rocker arm and the cam and another gap between the rocker arm and the valve bridge.

Although the engine brake system disclosed in the '116 patent has enjoyed considerable commercial success due to its high performance and compact size, it has some drawbacks. One of the drawbacks is that the engine braking rocker arm could get away from the neutral position and contact the cam and the valve bridge during the normal engine operation. The braking piston in the rocker arm would be hammered and get loose to cause serious engine damage.

Additional disadvantages of the prior art system reside in their relative complexity and the necessity for using precision components because of the need of accurate control of the rocker arm position and the braking piston stroke. Thus the system is comparatively expensive and difficult or impossible to install on certain engines.

### Bleeder Type Engine Brake (BTEB)

The operation of a bleeder type engine brake (BTEB) has also long been known. During bleeder type engine braking, in addition to the normal exhaust valve lift, the exhaust valve(s) may be held slightly open during a portion of the cycle (partial-cycle bleeder brake) or open continuously throughout the non-exhaust strokes (intake stroke, compression stroke, and expansion or power stroke) (full-cycle bleeder brake). The primary difference between a partial-cycle bleeder brake and a full-cycle bleeder brake is that the former does not have exhaust valve lift during most of the intake stroke.

U.S. Pat. No. 5,692,469 and U.S. Pat. No. 7,013,867 (“the '469 and '867 patents”) disclose a bleeder type engine brake (BTEB) system for engines with one and two exhaust valves per cylinder. The BTEB system works with a throttling device (also known as an exhaust brake) capable of raising exhaust pressure high enough to cause each exhaust valve to float near the end of each intake stroke. In this intermediate opening or floating of the exhaust valve, it is possible to intervene with the braking device so that the exhaust valve, which is about to close after the intermediate opening, is intercepted by a control piston charged with oil pressure and prevented from closing to create a partial cycle bleeder braking event. This is a Type IV engine brake.

The BTEB system of the type described above may not be reliable because it depends on the intermediate opening or floating of the braking exhaust valve, which is not consistent, both in timing and magnitude. As is well known in the art, exhaust valve floating is highly engine speed dependent and affected by the quality and control of the exhaust brake, and also the design of the exhaust manifold. There may be not enough or none valve floating for the actuation of the engine braking device at middle and low engine speeds when the engine brake is highly demanded since the engine is mostly driving at such speeds.

It is clear from the above description that the prior-art engine brake systems have one or more of the following drawbacks:

(a) The system is difficult to stay at a neutral position and could cause engine damage;

(b) The system is difficult to manufacture and has high complexity and cost;

(c) The system is not reliable and only work at certain engine speeds.

### SUMMARY OF THE INVENTION

The engine braking apparatus of the present invention addresses and overcomes the foregoing drawbacks of prior art engine braking systems.

One object of the present invention is to provide an engine braking apparatus that does not need a neutral position. It will stay at either “off” or “on” position. When the braking apparatus is at the “off” position, it will be biased to the inoperative position and disengaged from the normal engine operation.

Another object of the present invention is to provide an engine braking apparatus with fewer components, reduced complexity and manufacturing tolerance, lower cost, and increased system reliability.

Still a further object of the present invention is to provide an engine braking apparatus that is simple in construction, easy to install, reliable in operation and effective at all engine speeds.

The apparatus of the present invention converts an internal combustion engine from a normal engine operation to an engine braking operation. The engine includes an exhaust valve train that contains at least one exhaust valve and an exhaust valve lifter for cyclically opening and closing the at least one exhaust valve. The apparatus has an actuation means containing a dedicated load supporting system installed on the engine and a hydraulic system integrated in the exhaust valve train. The actuation means has an inoperative position and an operative position. The apparatus also has a control means for moving the actuation means between the inoperative position and the operative position to achieve the conversion between the normal engine operation and the engine braking operation.

The hydraulic system contains a hydraulic piston slidably disposed in the exhaust valve train between the inoperative position and the operative position. In the inoperative position, the hydraulic piston is retracted and separated from the dedicated load supporting system, and the actuation means is disengaged from the at least one exhaust valve. In the operative position, the hydraulic piston is extended and engaged with the dedicated load supporting system, and the actuation means opens the at least one exhaust valve for the engine braking operation.

The dedicated load supporting system can be a dedicated valve lifter containing a cam. The cam has at least one small cam lobe dedicated to the engine braking operation. During the engine braking operation, the dedicated valve lifter will act on the extended hydraulic piston and open the at least one exhaust valve.

The dedicated load supporting system can also be a housing installed on the engine. During the engine braking operation, the hydraulic piston will be fully extended after the at least one exhaust valve is opened by the exhaust valve lifter. The opened exhaust valve is blocked from returning to its seat and held open by the extended hydraulic piston. The engine braking load is transmitted to the housing through the hydraulic piston.

The engine braking apparatus according to the embodiments of the present invention have many advantages over the prior art engine braking systems, such as better performance and reliability, fewer components, reduced complexity, and lower cost.

### BRIEF DESCRIPTION OF THE DRAWINGS

These and other advantages of the present invention will become more apparent from the following description of the preferred embodiments in connection with the following figures.

FIG. 1 is a flow chart illustrating the general relationship between a normal engine operation and an added engine braking operation according to one version of the present invention.

FIGS. 2A and 2B are schematic diagrams of an engine brake control mean at its “on” or “feeding” position and its “off” or “drain” position according to one version of the present invention.

FIGS. 3A and 3B are schematic diagrams of an engine braking apparatus at the “off” and “on” positions according to a first embodiment of the present invention.

FIGS. 4A and 4B are schematic diagrams of an engine braking apparatus at the “off” and “on” positions according to a second embodiment of the present invention.

FIG. 5 is a schematic diagram of an engine braking apparatus at the “off” positions according to a third embodiment of the present invention.

FIG. 6 is a schematic diagram of an engine braking apparatus at the “off” positions according to a fourth embodiment of the present invention.

### DETAILED DESCRIPTION OF THE PREFERRED EMBODIMENTS

Reference will now be made in detail to presently preferred embodiments of the invention, examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

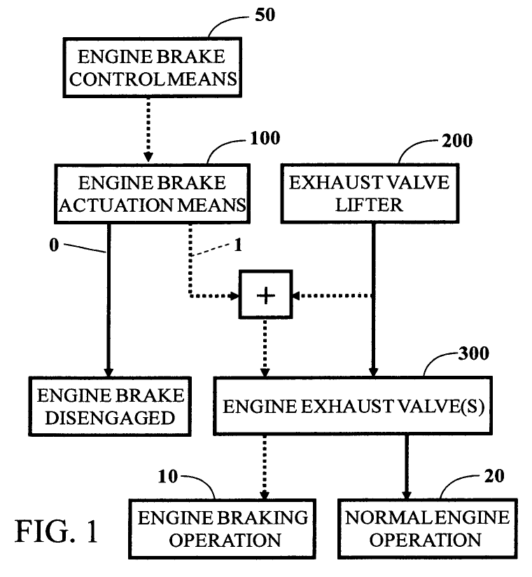

FIG. 1 is a flow chart illustrating the general relationship between a normal engine operation 20 and an added engine braking operation 10 according to one version of the present invention. An internal combustion engine contains an exhaust valve system 300 and an exhaust valve lifter 200 for cyclically opening and closing the exhaust valve during the normal engine operation 20. The engine braking operation 10 is achieved through engine brake control means 50 and engine brake actuation means 100 that contains an inoperative position 0 and an operative position 1. To convert the engine from its normal operation 20 to the braking operation 10, the control means 50 will move the actuation means 100 from the inoperative position 0 to the operative position 1. By default, the control means 50 is at its off position, the actuation means 100 at the inoperative position 0, and the engine brake disengaged from the exhaust valve system 300 and the engine operation.

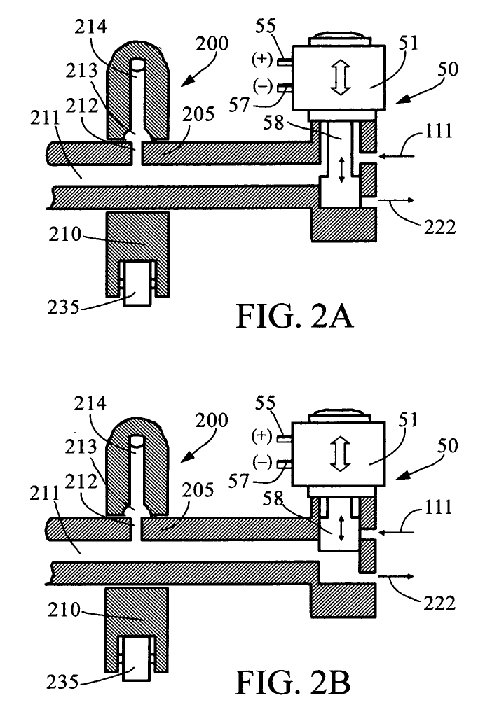

FIGS. 2A and 2B are schematic diagrams of an engine brake control means 50 at the “off” and “on” position. When engine braking is needed, the control means 50 containing a three-way solenoid valve 51 is turned on by electric current through the positive and negative terminals 55 and 57 as shown in FIG. 2A. The spool valve 58 is moved down and the port 111 is opened to allow engine oil to a brake fluid circuit containing a flow passage 211 in the rocker shaft 205 of the engine. The engine oil flow passes a radial orifice 212, through an undercut 213, and into a flow passage 214 in the rocker arm 210. Details of the exhaust valve lifter 200 will be shown in the following figures. When engine braking is not needed, the three-way solenoid valve 51 is turned off as shown in FIG. 2B, the port 111 is closed and the port 222 opened to allow engine oil to flow out of the engine braking fluid circuit. Note that the control means 50 could be remotely located and used for controlling multiple cylinder engine brakes, and the brake fluid circuit may reach other components of the engine. Also, by blocking the port 222, the three-way solenoid valve 51 is changed to a two-way solenoid valve.

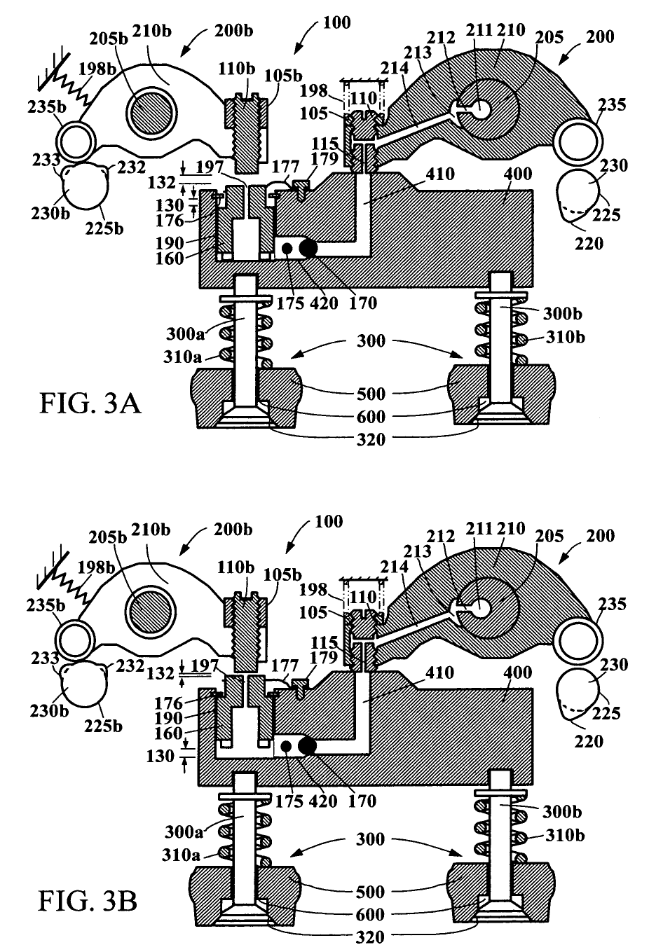

FIGS. 3A and 3B are schematic diagrams of an engine braking apparatus at the “off” and “on” position according to one embodiment of the present invention. There are three major sub-systems: the engine brake actuation means 100, an exhaust valve lifter 200 and an exhaust valve system 300. The exhaust valve lifter 200 and the exhaust valve system 300 form the so called exhaust valve train. The engine brake actuation means 100 contains a dedicated load supporting system, so that the huge engine braking load is not supported by the exhaust valve lifter 200. The dedicated load supporting system in this embodiment is a brake valve lifter 200b dedicated to engine braking. This is a compression release engine braking (CREB) system with a dedicated valve lifter 200b (Type III engine brake).

The exhaust valve lifter 200 has components that include a cam 230, a cam follower 235, a rocker arm 210, and a valve bridge 400. The exhaust cam 230 contains a large lobe 220 above the inner base circle 225 for the normal engine operation. The rocker arm 210 can pivot on the rocker shaft 205. One end of the rocker arm 210 has a cam follower 235 while the other end contains a lash adjusting screw 110 that contacts the valve bridge 400. Normally there is an elephant foot attached to the lash adjusting screw 110, but not shown here for simplicity. The lash adjusting screw 110 contains a flow passage 115 and is secured to the rocker arm 210 by a lock nut 105. A spring 198 may be used on the top of the adjusting screw 110 or other places to bias the rocker arm 210 against the valve bridge 400 for better sealing of the engine oil.

The dedicated braking valve lifter 200b includes a cam 230b, a cam follower 235b, a rocker arm 210b and a valve lash adjusting means. The braking cam 230b has two small cam lobes 232 and 233 above the inner cam base circle 225b for the engine braking operation. The braking rocker arm 210b can pivot on the rocker shaft 205b and is normally biased to the inoperative position, for example, to the cam 230b by a spring 198b. The valve lash adjusting means includes a lash adjusting screw 110b that is secured to the rocker arm 210b by a lock nut 105b.

The exhaust valve system 300 contains at least one exhaust valve. Here two valves 300a and 300b (or simply 300) are shown. They are biased upwards against their seats 320 on the engine cylinder head 500 by engine valve springs 310a and 310b (or 310) to seal gas (air, during engine braking) from flowing between the engine cylinder and the exhaust manifolds 600. Normally, mechanical input from the cam 230 is transmitted to both exhaust valves 300 through the exhaust valve lifter 200 for their cyclical opening and closing. During engine braking, additional cam motion from the two small braking cam lobes 232 and 233 are transmitted through the brake dedicated valve lifter 200b to only one of the exhaust valves, for example, 300a. The valve lift for engine braking is about 2 millimeters, much smaller than the main exhaust valve lift (>10 millimeters) during the normal engine operation.

The engine brake actuation means 100 further includes a hydraulic system having a hydraulic piston (or braking piston) 160 slidably disposed in the exhaust valve train, here in the valve bridge 400, between the inoperative position and the operative position. Normally, the braking piston 160 is biased to the inoperative position by a spring 177 and separated from the dedicated valve lifter 200b by a lash 132 set by the lash adjusting means when the cam 230b is at its inner base circle 225b as shown in FIG. 3A. The lash 132 is equal to or slightly larger than the motion or stroke 130 of the braking piston 160. Therefore, the engine braking actuation means 100 is disengaged from the exhaust valve 300a. One end of the spring 177 is on the braking piston 160 and the other end is secured on the valve bridge 400 by a screw 179. There may be other components that are not shown here for simplicity, such as an elephant foot that may be connected to the lower portion of the lash adjusting screw 110b. The hydraulic system further contains a one-way check valve 170 and the brake fluid circuit formed in said exhaust valve train.

When engine braking is needed, the engine brake control means 50 is turned on (FIG. 2A) to allow engine oil to flow to the braking piston 160 through the brake fluid circuit that further includes the flow passage 115 in the lash adjusting screw 110 and a flow passage 410 in the valve bridge 400 as shown in FIGS. 3A and 3B. The engine oil pushes the one-way check valve 170 open against a pin 175. Oil pressure overcomes the load of spring 177 and pushes the braking piston 160 out of the bore 190 in the valve bridge 400 to the operative or extended position as shown in FIG. 3B. The braking piston 160 is stopped at the clip ring 176 with a stroke of 130, and the lash or gap 132 is taken up or greatly reduced. As the braking cam 230b rotates, the motion from the small braking cam lobes 232 and 233 is transmitted to the exhaust valve 300a through the braking piston 160 and the valve bridge 400 for the engine braking operation, because the braking piston 160 is extended and hydraulically locked to the operative position by the one-way check valve 170. Also the normally opened bleeding orifice 197 in the braking piston 160 is blocked or sealed by the lash adjusting screw 110b or the elephant foot on the dedicated braking valve lifter 200b when the braking piston 160 is actuated or loaded by the small cam lobes 232 and 233 on the brake cam 230b.

When engine braking is not needed, the engine brake control means 50 is turned off (FIG. 2B) and there will be no oil supplied to the brake fluid circuit. The oil under the braking piston 160 will bleed out of an orifice 197 under the load of spring 177. The braking piston 160 will retract into the bore 190 and disengage from the dedicated braking valve lifter 200b as shown in FIG. 3A so that the small braking cam lobes 232 and 233 are skipped. The engine brake means 100 is now at the inoperative position and disengaged from the normal engine operation.

The embodiment as shown in FIGS. 3A and 3B could be modified or varied without departing from the scope and spirit of the present invention. For instance, the cam shaft for the engine braking cam 230b can be a separate one or the same one as for the normal exhaust cam 230, and the rocker arm shaft for the engine braking rocker arm 210b can be a separate one 205b or the same one 205 as for the normal rocker arm 210. The spring 198 or 198b can also take a different type than the coil spring, for example, a flat or leaf spring, or a torsion spring. Another spring could be added to bias the one-way check valve 170 to its seat.

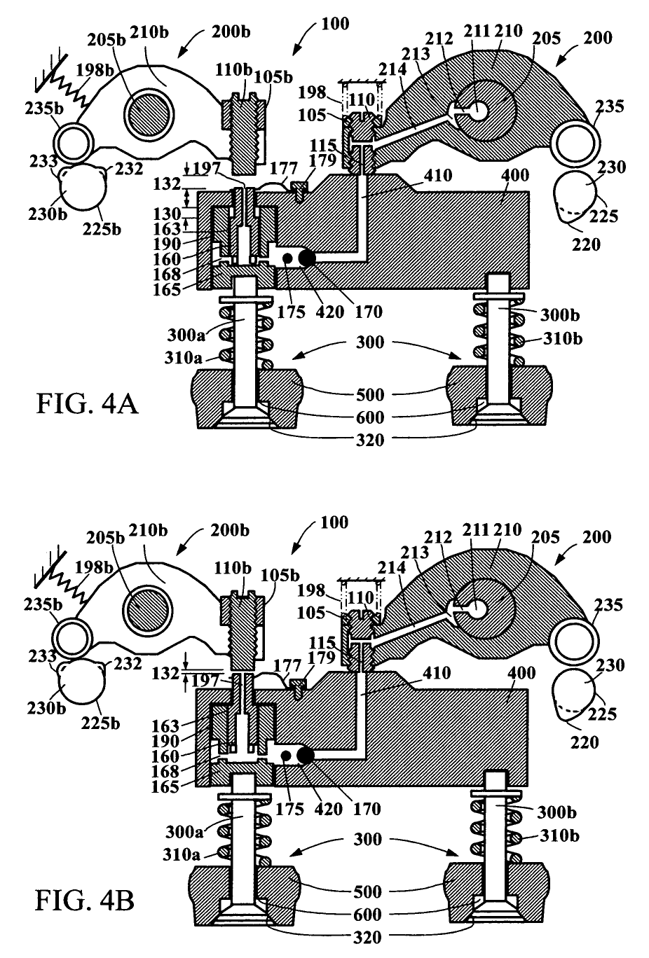

FIGS. 4A and 4B show a different version of the embodiment in FIGS. 3A and 3B with an added guide piston 165 in the valve bridge 400, while the hydraulic or braking piston 160 is now slidably disposed in a bore 163 in the guide piston 165 between an inoperative position and an operative position.

When engine braking is needed, the engine brake control means 50 is turned on (FIG. 2A) to allow engine oil to flow to the braking piston 160 through the brake fluid circuit that further includes the flow passage 115 in the lash adjusting screw 110, a flow passage 410 in the valve bridge 400, and a flow passage 168 across the guide piston 165 as shown in FIGS. 4A and 4B. The engine oil pushes the one-way check valve 170 open against a pin 175. Oil pressure overcomes the load of spring 177 and pushes the braking piston 160 out of the bore 163 in the guide piston 165 to the extended or operative position as shown in FIG. 4B. The braking piston 160 is stopped at the top of bore 190 in the valve bridge 400 with a stroke of 130, and the lash or gap 132 is taken up or greatly reduced. As the braking cam 230b rotates, the motion from the small braking cam lobes 232 and 233 is transmitted to the exhaust valve 300a through the braking piston 160 and the guide piston 165 for the engine braking operation, because the braking piston 160 is hydraulically locked to the extended position by the one-way check valve 170 and the sealed bleeding orifice 197 by the loaded braking piston 160 and the dedicated brake valve lifter 200b.

During the normal engine operation or when engine braking is not needed, the engine brake control means 50 is turned off (FIG. 2B) and there will be no oil supplied to the engine braking fluid circuit. The oil under the braking piston 160 will bleed out of an orifice 197 under the load of spring 177. The braking piston 160 will retract and disengage from the dedicated braking valve lifter 200b as shown in FIG. 4A so that the small braking cam lobes 232 and 233 are skipped. The engine brake means 100 is now at the inoperative position and disengaged from the normal engine operation.

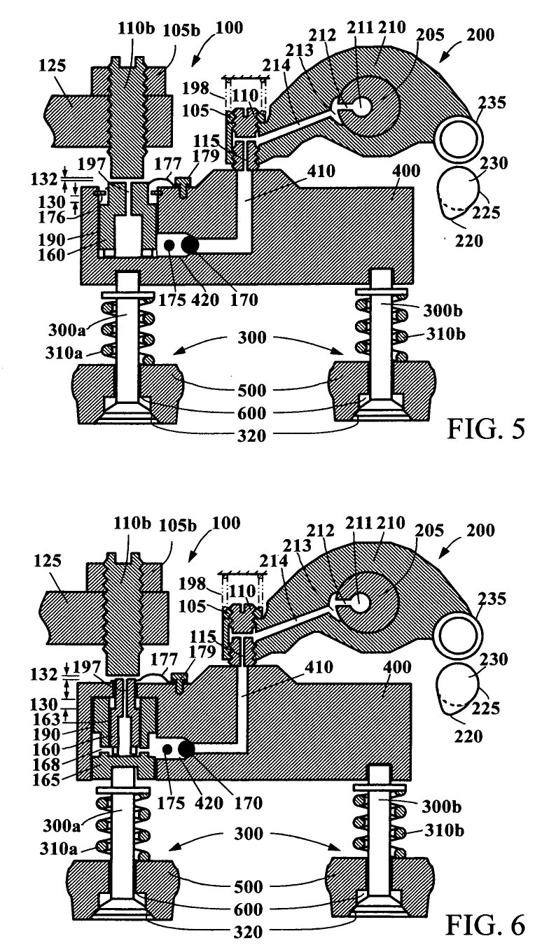

FIG. 5 is a schematic diagram of an engine braking apparatus according to another embodiment of the present invention. It is similar to the embodiment shown in FIGS. 3A and 3B except that the dedicated load supporting system does not have the dedicated valve lifter 200b but a housing 125. The housing also includes a valve lash adjusting means containing the lash adjusting screw 110b secured on the housing 125 by a lock nut 105b. Therefore, the braking valve lift is not achieved by the actuation of the small cam lobes 232 and 233, but by preventing the exhaust valve 300a that is opened by the exhaust valve lifter 200 from closing or returning to its seat.

When engine braking is needed, oil is supplied to the brake fluid circuit through the control means 50 and trying to push the braking piston 160 out of the bore 190 in the valve bridge 400. However, the braking piston 160 can't move to the fully open position when the exhaust valve 300a is seated because the piston stroke 130 is larger than the valve lash 132 set by the valve lash adjusting means. The braking piston 160 is waiting for the lift or opening of the exhaust valve 300a. Only after the exhaust valve 300a is pushed down by the exhaust valve lifter 200, the braking piston 160 can be fully extended and hydraulically locked to the operative position by the one-way check valve 170. Now the opened exhaust valve 300a can't return to its seat but is held open by the fully extended and hydraulically locked braking piston 160. Also, the bleeding orifice 197 is blocked or sealed by the loaded braking piston 160 against the housing 125 or the lash adjusting screw 110b. The opening or lift of the braking valve 300a equals to the difference between the piston motion or stroke 130 and the lash 132. Therefore, this is a bleeder type engine brake (BTEB).

When engine braking is not needed, there will be no oil supplied to the brake fluid circuit and the oil under the braking piston 160 will bleed out of the orifice 197 under the load of spring 177. The braking piston 160 will retract into the bore 190 in the valve bridge 400 and separate from the housing 125 or the lash adjusting screw 110b as shown in FIG. 5. The engine brake means 100 is now at the inoperative position and disengaged from the exhaust valve 300a.

FIG. 6 shows a new embodiment formed with the features in FIG. 5 and FIGS. 4A and 4B combined. It has the dedicated load supporting system as shown in FIG. 5 and the hydraulic system integrated in the exhaust valve train as shown in FIGS. 4A and 4B. Therefore, its working mechanism and operation are obvious and not explained here for simplicity.

### CONCLUSION, RAMIFICATIONS, AND SCOPE

It is clear from the above description that the engine braking apparatus according to the embodiments of the present invention have one or more of the following advantages over the prior art engine braking systems.

First, the compression release engine brake (CREB) systems disclosed here have fewer components, less complexity, and lower cost. Different from the prior art engine braking system disclosed by the '116 patent, the dedicated brake rocker arm 210b is not at the neutral position but biased to the cam. Therefore, the systems disclosed here will not interfere with the normal engine operation.

Second, the bleeder type engine brake (BTEB) systems disclosed here have a control means 50 for active control of the engine brake actuation means 100. Different from the prior art engine braking system disclosed by the '469 and '867 patents, the actuation of the engine brake systems disclosed here does not depend on valve floating. Therefore, the BTEB systems disclosed here are more reliable, tolerant with different exhaust brakes, and effective at all engine speeds.

While my above description contains many specificities, these should not be construed as limitations on the scope of the invention, but rather as an exemplification of the preferred embodiments thereof. Many other variations are possible. For example, the rocker arm 210b biased to the cam 230b can be set to the inoperative position through other mechanism, such as using a spring system to hold the rocker arm 210b so that it separates from the cam 230b and the braking piston 160. Different from the prior art engine braking system disclosed by the '116 patent, the hydraulic system disclosed here is not integrated into the dedicated brake rocker arm 200b. Therefore, there is no such risk that the braking piston 160 would be knocked and get loose to cause engine damage.

Also, the apparatus disclosed here can be applied to a push tube type engine instead of the overhead cam type engine.

Also, the apparatus disclosed here can be applied to other engine valve train containing the engine valve system and the engine valve lifter, such as the intake valve system and the intake valve lifter.

Also, the dedicated load supporting system installed on said engine could be different, for example, a housing fixed on the engine, or a rocker arm pivoting on a rocker shaft. The system could contain a cam, for example, the cam 230b for a compression release type (Type III) engine brake, or no cam for a bleeder type (Type IV) engine brake.

Also, a poppet type solenoid valve could be used to replace the spool type valve 51 of the control means 50 as shown in FIGS. 2A and 2B.

Also, the dedicated valve lifter 200b can be used to produce other auxiliary valve event. In general, the engine valve lift can be modified to produce an engine valve event that is different from the normal engine operation. The engine valve event could be the engine braking operation, an exhaust valve EGR event or an intake valve EGR event, etc.

Accordingly, the scope of the invention should be determined not by the embodiments illustrated, but by the appended claims and their legal equivalents.

I claim:

1. Apparatus for converting an internal combustion engine from a normal engine operation to an engine braking operation, said engine having an exhaust valve train comprising at least one exhaust valve and an exhaust valve lifter for cyclically opening and closing the at least one exhaust valve, said apparatus comprising:
(a) actuation means comprising a dedicated load supporting system installed on said engine and a hydraulic system integrated in said exhaust valve train; said actuation means having an inoperative position and an operative position; in said inoperative position, said actuation means being disengaged from the at least one exhaust valve, and in said operative position, said actuation means opening the at least one exhaust valve for said engine braking operation; and
(b) control means for moving said actuation means between said inoperative position and said operative position to achieve the conversion between the normal engine operation and the engine braking operation.

2. The apparatus of claim 1 wherein said hydraulic system comprises a hydraulic piston slidably disposed in said exhaust valve train between said inoperative position and said operative position; in said inoperative position, said hydraulic piston being retracted and separated from said dedicated load supporting system; in said operative position, said hydraulic piston being extended and engaged with said dedicated load supporting system.

3. The apparatus of claim 1 wherein said hydraulic system further comprises a one-way check valve and a brake fluid circuit in said exhaust valve train.

4. The apparatus of claim 1 wherein said dedicated load supporting system comprises a dedicated valve lifter, said dedicated valve lifter containing a cam, and said cam having at least one small cam lobe dedicated to the engine braking operation.

5. The apparatus of claim 1 wherein said dedicated load supporting system further comprises a spring for biasing said dedicated valve lifter to the inoperative position.

6. The apparatus of claim 1 wherein said dedicated load supporting system further comprises a housing installed on said engine.

7. The apparatus of claim 1 wherein said dedicated load supporting system further comprises a valve lash adjusting means for setting a lash between said dedicated load supporting system and said hydraulic piston.

8. The apparatus of claim 1 wherein said control means comprises an electro-hydro-mechanical system, said electro-hydro-mechanical system comprising a solenoid valve for supplying and cutting off a fluid flow to said hydraulic piston through said brake fluid circuit; and said fluid flow controlling the motion of said hydraulic piston between the inoperative position and the operative position.

9. The apparatus of claim 1 wherein said control means further comprises a bleeding orifice for draining the fluid flow under said hydraulic piston.

10. A method of modifying engine valve lift in an internal combustion engine to produce an engine valve event that is different from a normal engine operation, said engine having an engine valve train comprising at least one engine valve and an engine valve lifter for cyclically opening and closing the at least one engine valve, said method comprising the steps of:
(a) providing a dedicated load supporting system, said dedicated load supporting system comprising a dedicated valve lifter;
(b) providing a hydraulic piston slidably disposed in said engine valve train between an inoperative position and an operative position, and a control means for moving said hydraulic piston;
(c) turning on said control means;
(d) moving said hydraulic piston from said inoperative position to said operative position;
(e) acting on said hydraulic piston by said dedicated valve lifter; and
(f) opening the at least one engine valve to produce said modified engine valve lift for said engine valve event.

11. The method of claim 10 further comprising the steps of:
(a) providing a lash adjusting means incorporated into said dedicated valve lifter;
(b) setting a lash between said dedicated valve lifter and said hydraulic piston, said lash being equal to or slightly larger than the motion of said hydraulic piston.

12. The method of claim 10 further comprising the steps of:
(a) providing a dedicated load supporting system, said dedicated load supporting system comprising a housing installed on said engine;
(b) turning on said control means;
(c) opening the at least one engine valve by said engine valve lifter;
(d) moving said hydraulic piston from said inoperative position to said operative position by said control means; and
(e) blocking the opened engine valve from closing and holding it open by said hydraulic piston and said housing to produce said modified engine valve lift for said engine valve event.

13. The method of claim 12 further comprising the steps of:
(a) providing a lash adjusting means incorporated into said housing;
(b) setting a lash between said housing and said hydraulic piston, said lash being equal to the motion of said hydraulic piston minus said modified engine valve lift.

14. The method of claim 10 further comprising the steps of:
(a) providing a bleeding orifice;
(b) providing a spring for biasing said hydraulic piston to the inoperative position;
(c) turning off said control means;
(d) separating said hydraulic piston from said dedicated load supporting system by said engine valve lifter;
(e) draining the fluid flow under said hydraulic piston through said bleeding orifice; and
(f) pushing said hydraulic piston to the inoperative position by said spring.
